(19) United States
(12) Patent Application Publication
(10) Pub. No.: US 2022/0266273 A1
(43) Pub. Date: Aug. 25, 2022

(54) POWDER COATING SPRAY GUN RESERVOIR ASSEMBLY

(71) Applicant: Xerox Corporation, Norwalk, CT (US)

(72) Inventors: Jack T. LeStrange, Macedon, NY (US); Anthony Salvatore Condello, Webster, NY (US); Palghat S. Ramesh, Pittsford, NY (US); Joseph Charles Sheflin, Macedon, NY (US); Peter John Knausdorf, Henrietta, NY (US)

(21) Appl. No.: 17/180,196

(22) Filed: Feb. 19, 2021

(51) Int. Cl. B05B 5/16; B05B 5/047

(52) U.S. Cl. CPC B05B 5/1683; B05B 5/047

(57) ABSTRACT

A powder coating spray gun reservoir assembly, including a first section including a first end, a second end, and a first lateral wall extending between the first end and the second end, a second section including a third end engaged with the second end, a fourth end, and a second lateral wall extending between the third end and the fourth end, a screen removably arranged between the first section and the second section, and an agitator rotatably arranged in the first section, wherein the agitator is operatively arranged to rotate relative to the screen to displace powder from the first section to the second section.

### FIELD

The present disclosure relates to the field of powder coating, and more particularly, to reservoirs for powder coating guns, and even more particularly, to a powder coating spray gun reservoir assembly that entrains ultra-fine particles with air.

### BACKGROUND

The industry for finishing metal surfaces with dry powder coatings began in the mid-1950s. The initial applications of electrostatic powder coating involved the coating of pipe and electric motors. With the growing need to reduce air position from solvent-based paints, the demand for electrostatic powder coating has increased over the years. Although the cost of powder and liquid coatings are comparable, powder coating is advantaged in that 1) spray booths are easily cleaned, 2) no solvents are used which eliminates the need for air pollution control equipment, 3) overspray can be collected for reuse, 4) a film thickness of 1 to 3 millimeters can be obtained in one powder application, 5) primers are often no necessary, 6) powder has no surface tension so it will penetrate into small gaps precluded by liquid paint, and 7) there are no unsightly runs or drips, as often results with the use of wet paint. The coatings produced with powder are more chip resistant since the thermoset material is cured at high temperatures (e.g., 300-425° F.).

The electrostatic powder coating process provides a simple method for spray-painting a polymeric powder onto articles that range in size from hand tools to automobiles. In the electrostatic powder coating process, a thermoset powder is typically pneumatically fed to a spray gun from an air fluidized powder reservoir. This powder does not contain surface additives to improve fluidization since the quality of film formation during the oven-curing step would be compromised. With this materials constraint, the industry typically uses a larger powder (e.g., 30-40 μm average diameter) that is easily fluidized. The spray gun charges the powder by either triboelectric charging or corona ions. A combination of electrostatic and pneumatic forces transports the charged powder to the article to be coated, which is usually connected to ground. Electrostatic image forces attract the charged powder to the article. The coated part is typically baked in an oven for approximately 10 minutes at approximately 400° F., wherein the powder metals and flows into a durable film.

To achieve high quality coatings with thin layers, there is a need to electrostatically powder coat articles with a powder size of approximately 10 μm. Small powder size allows for the application of thin layers, low-temperature curing (and possibly ultra-violet (UV) curing, and custom color selection. However, currently, suppliers can only obtain an average powder size of 30-40 μm since there are issues associated with small powder size. Powder sizes that are smaller than 30-40 μm tend to clump and are difficult to fluidize, or adequately mix with air. Additionally, the current powder fluidization process is low-energy and cannot effectively break up powder agglomerates. The powder fluidization process fails when the powder particle size mean is small (i.e., less than 40 μm) or if too many fines (i.e., particles with diameters of less than 10 μm) make up the powder particle size distribution, which is why current powder coating uses powders with fairly large particle diameters. Furthermore, the use of large particles precludes the creation of custom colors. Large particle powders may be mixed together but result in a non-uniform coating (i.e., the coating is speckled and the colors do not appear to be mixed well to the human eye). This inhomogeneity is due to agglomeration of each color to particles of the same color and to non-uniform charging of the two colors (i.e., by tribo powder coating guns). The fluidization of small particle powders would allow for mixing of multiple powder colors to form custom colors.

Thus, there is a long-felt need to provide a powder coating spray gun reservoir assembly that fluidizes powders of very small size (i.e., approximately 10 μm) and effectively breaks up powder agglomerates.

### SUMMARY

According to aspects illustrated herein, there is provided a powder coating spray gun reservoir assembly, comprising a first section including a first end, a second end, and a first lateral wall extending between the first end and the second end, a second section including a third end engaged with the second end, a fourth end, and a second lateral wall extending between the third end and the fourth end, a screen removably arranged between the first section and the second section, and an agitator rotatably arranged in the first section, wherein the agitator is operatively arranged to rotate relative to the screen to displace powder from the first section to the second section.

In some embodiments, the screen is non-rotatably connected to at least one of the first section and the second section. In some embodiments, the agitator is engaged with the screen. In some embodiments, the agitator comprises a shaft, and at least one first blade connected to the shaft and operatively arranged to rotatably engage the screen. In some embodiments, the agitator further comprises at least one second blade connected to the shaft and axially spaced apart from the at least one first blade. In some embodiments, the powder coating spray gun reservoir assembly further comprises a nozzle connected to the fourth end, wherein the nozzle decreases in diameter in a first axial direction away from the fourth end. In some embodiments, the second section is removably connected to the first section. In some embodiments, the powder coating spray gun reservoir assembly further comprises a cap removably connected to the first end. In some embodiments, the powder coating spray gun reservoir assembly further comprises an air inlet arranged in the cap. In some embodiments, the air inlet is operatively arranged to direct an air stream into the first section in a first axial direction. In some embodiments, the powder coating spray gun reservoir assembly further comprises an air inlet arranged in the second lateral wall. In some embodiments, the air inlet is operatively arranged to direct an air stream into the second section in a first circumferential direction. In some embodiments, the powder coating spray gun reservoir assembly further comprises a corona charging device arranged in the second section to charge the powder. In some embodiments, at least one of the screen and the agitator comprises polytetrafluoroethylene (PTFE) and is operatively arranged to triboelectrically charge the powder.

According to aspects illustrated herein, there is provided a powder coating spray gun reservoir assembly, comprising a first section including a first end, a second end, and a first lateral wall extending between the first end and the second end, a second section including a third end engaged with the second end, a fourth end, and a second lateral wall extending between the third end and the fourth end, a nozzle connected to the fourth end, the nozzle decreasing in diameter in a first axial direction, a screen removably secured between the first section and the second section, an agitator rotatably arranged in the first section, the agitator including a shaft, and at least one first blade connected to the shaft and operatively arranged to engage the screen, and a charging device; wherein the agitator is operatively arranged to rotate relative to the screen to displace powder from the first section to the second section.

In some embodiments, the agitator further comprises at least one second blade connected to the shaft and axially spaced apart from the at least one first blade. In some embodiments, the second section is removably connected to the first section. In some embodiments, the powder coating spray gun reservoir assembly further comprises an air inlet operatively arranged to direct an air stream into at least one of the first section and the second section. In some embodiments, the charging device comprises a corona charging device operatively arranged to charge the powder. In some embodiments, the powder coating spray gun reservoir assembly further comprises an output connected to the nozzle, wherein the corona charging device is arranged in the outlet. In some embodiments, the corona charging device comprises a tube extending radially into the outlet, and an electrode arranged in the tube, wherein an air stream is directed through the tube along the electrode to ionize powder passing through the outlet. In some embodiments, the charging device comprises at least one element operatively arranged to triboelectrically charge the powder. In some embodiments, at least one of the screen and the agitator comprises polytetrafluoroethylene (PTFE) and is operatively arranged to triboelectrically charge the powder.

According to aspects illustrated herein, there is provided a method of fluidizing powder for use in a powder coating spray gun, the method comprising storing un-sifted powder in a first section, using an agitator, sifting the un-sifted powder through a screen to form sifted powder in a second section, and injecting an air stream into at least one of the un-sifted powder and the sifted powder.

In some embodiments, the method further comprises charging the sifted powder. In some embodiments, the method further comprises charging the sifted powder using a corona charging device arranged proximate the second section. In some embodiments, the method further comprises charging the un-sifted powder and/or the sifted powder triboelectrically using at least one of the screen and the agitator. In some embodiments, the step of storing un-sifted powder in the first section comprises storing a first un-sifted powder in the first section, the first un-sifted powder having a first color, and storing a second un-sifted powder in the first section, the second un-sifted powder having a second color, the second color being different than the first color. In some embodiments, the method further comprises using the agitator, mixing the first un-sifted powder and the second un-sifted powder to form a third un-sifted powder, the third un-sifted powder having a third color, the third color being different than the first color and the second color. In some embodiments, the step of sifting the un-sifted powder through the screen to form the sifted powder comprises using the agitator, mixing the first un-sifted powder and the second un-sifted powder to form a third un-sifted powder, the third un-sifted powder having a third color, the third color being different than the first color and the second color, and using the agitator, sifting the third un-sifted powder through the screen to form the sifted powder in the second section. In some embodiments, the step of sifting the un-sifted powder through the screen to form the sifted powder comprises using the agitator and the screen, mixing and sifting the first un-sifted powder and the second un-sifted powder to form the sifted powder in the second section, the sifted powder having a third color, the third color being different than the first color and the second color.

According to aspects illustrated herein, there is provided a powder coating spray gun reservoir assembly. The assembly comprises a top feed powder hopper that incorporates a fine mesh screen with a rotating agitator. The screen mesh is chosen to prevent a significant portion of powder from passing through the screen under static conditions (possibly at the 95% percentile particle diameter). The rotating agitator forces the powder through the screen as it rotates. In some embodiments, the agitator remains fixed and the mesh screen rotates relative to the agitator to force powder down through the screen. Airflow can be directed from the top of the hopper through the screen, aiding in pushing powder through the screen, or can be introduced below the screen where the relatively sparse powder is easily entrained into the airflow. Not only does the fine mesh screen create a cloud of powder that can be easily entrained into an airstream, but it also prevents large powder agglomerates from passing through the spray gun and onto the coated part.

In some embodiments, the rotating agitator may comprise additional blades in the plane of the screen or at various positions along the drive shaft to agitate and mechanically fluidize the powder above the screen. These additional blades along the shaft could have wing-like shapes to optimally agitate the powder. Additionally, the agitator contacting the screen can be rods or brush material. To ensure good contact between the screen and the rotating agitator, a slight bend in the agitator blades may be required or the blades may be slightly flexible. In some embodiments, the blades are angled toward the screen so as to, when rotated about the shaft, force powder and air downward through the screen (i.e., like a ceiling fan configuration). In some embodiments, the blades are rectangular shaped. In some embodiments, the blades are bars having a circular cross-section. The fine mesh screen will be removable, and a selection of screen mesh sizes can be available for powders of various diameters. The rate of powder that enters the spray gun can be controlled by adjusting the rotational speed of the agitator.

In some embodiments, the mesh screen and agitator comprise one or materials that triboelectrically charge the powder as it is forced through the screen with the agitator, for example, TEFLON® polytetrafluoroethylene (PTFE). In some embodiments, the reservoir assembly may further comprise an isolated bias-able layer on the interior of the reservoir assembly and powder gun exit tube to prevent/limit powder deposition on the inside of the reservoir assembly below the screen and exit tube (i.e., conductive layer biased to same polarity as the powder). In some embodiments, the powder is ion charged at the exit of the reservoir assembly (i.e., corona). A separate clean airflow supply with a center high voltage electrode at the exit of the hopper or reservoir assembly would ion charge the powder leaving the reservoir assembly.

In some embodiments, the reservoir assembly comprises two sections that can be disconnected to remove the screen arranged therebetween for each cleaning, for example, for color changeovers. In some embodiments, the powder coating spray gun reservoir assembly comprises one or more vibrating actuators to improve the sifting efficiency.

By enabling small diameter powder coating and mechanical screening or sifting of powders, mixing two powder colors together to create custom colors is possible, thereby circumventing the drawbacks of existing technology.

The powder coating spray gun reservoir assembly of the present disclosure has the following advantages: 1) it enables powder coating with small diameter powders (e.g., approximately 10 μm diameter mean and less) resulting in thin and smooth coated layers; 2) it allows powder mass flow rate to be tuned by adjusting the rotational speed of the screen agitator; 3) it allows for multi-color mixtures of powders to be used to achieve custom color powder coatings; 4) it allows the screen and agitator materials to be chosen so as to charge the powder; 5) it has a relatively simple design and is low cost; and 6) it could be designed to adapt to larger industrial spray systems with remote powder hoppers or reservoirs and to existing spray guns.

The present disclosure proposes the improvement of power coating equipment by the use of a rotating mesh screen to help in the fluidization of the coating particles. The use of a rotating screen will allow control of particle size by the choice of screen mesh size, and will allow control of particle dispense rate by varying the speed of the rotation. The present disclosure also discloses the idea of mixing multiple primary color media (or particles) to generate mixed custom colors. Currently the color of a coating is fixed by the color of the single particle media being used. The rotating screen will enable this mixing/custom color generation as it offers precise control of particle dispensing. Benefits of the present disclosure include better control of particle size and particle concentration in the fluidized particle air flow. It will also allow the mixing of primary color media to generate custom colors. The present disclosure may be applicable to other coating/dispensing applications as well.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a side cross-sectional view of a powder coating spray gun reservoir assembly;

FIG. 1B is a cross-sectional view of the powder coating spray gun reservoir assembly taken generally along line 1B-1B;

FIG. 2 is a side cross-sectional view of a powder coating spray gun reservoir assembly;

FIG. 3 is a side cross-sectional view of a powder coating spray gun reservoir assembly;

FIG. 4 is a partial perspective view of a blade engaged with a screen;

FIG. 5 is a partial perspective view of a blade engaged with a screen;

FIG. 6A is a partial perspective view of a blade engaged with a screen;

FIG. 6B is a partial elevational view of the blade shown engaged with the screen shown in FIG. 6A; and,

FIGS. 7A-B is a chart showing mesh size for a screen to micron size for particles.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, pneumatics, and/or springs.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

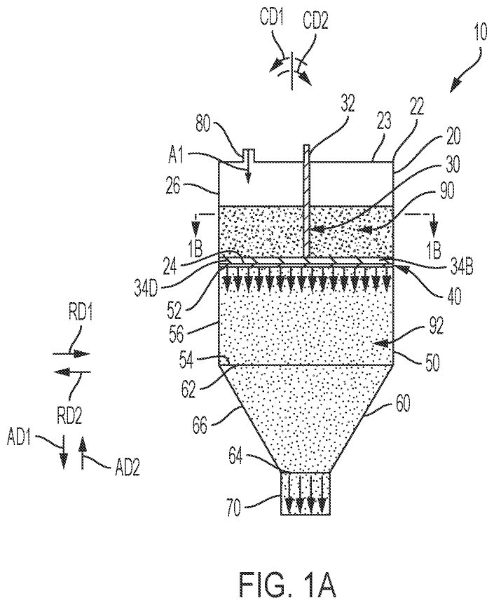

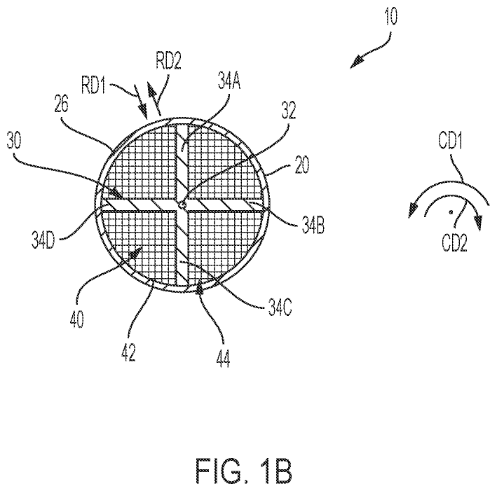

Referring now to the figures, FIG. 1A is a side cross-sectional view of powder coating spray gun reservoir assembly 10. FIG. 1B is a cross-sectional view of powder coating spray gun reservoir assembly 10 taken generally along line 1B-1B. Powder coating spray gun reservoir assembly or reservoir assembly 10 generally comprises first section 20, second section 50, screen 40, and agitator 30. In some embodiments, reservoir assembly 10 further comprises nozzle 60.

Section 20 is generally tubular and comprises end 22, end 24, and lateral wall 26. In some embodiments, and as shown in FIG. 1B, section 20 is a cylindrical tube. However, it should be appreciated that section 20 may comprise any cross-sectional geometry suitable for holding un-sifted powder 90 and allowing rotation of agitator 30 relative to screen 40 and/or screen 40 relative to agitator 30, for example, ovular, triangular, rectangular, square, ellipsoidal, etc. In some embodiments, reservoir assembly 10 further comprises cap 23 removably connected to section 20, specifically, end 22. Cap 23 encapsulates section 20. Cap 23 is removably connected to wall 26 to allow un-sifted powder 90 to be inserted into section 20, after which cap 23 is connected to wall 26 to prevent un-sifted powder 90 from spilling from section 20.

Section 50 is generally tubular and comprises end 52, end 54, and lateral wall 56. In some embodiments, section 50 is a cylindrical tube. However, it should be appreciated that section 50 may comprise any cross-sectional geometry suitable for enclosing sifted powder 92 and, in some embodiments, allowing rotation of screen 40 relative to agitator 30, for example, ovular, triangular, rectangular, square, ellipsoidal, etc. End 52 is removably connected to end 24.

Screen 40 is generally a plate including a plurality of apertures therein. Screen 40 may be, for example a perforated plate or cylinder or a meshed wire or cloth fabric. In some embodiments, screen 40 generally comprises rim 42 and mesh 44. Rim 42 is generally a rigid structure that is non-rotatably connected to at least one of section 20 and section 50. In some embodiments, wherein agitator 30 is non-rotatably connected to section 20, rim 42 may be rotatably connected to section 20 and/or section 50. In some embodiments, mesh 44 is non-rotatably connected to at least one of section 20 and section 50. Screen 40 is arranged between section 20 and section 30. In some embodiments, screen 40 is non-rotatably connected to and arranged radially within lateral wall 26 of section 20. In some embodiments, screen 40 is non-rotatably connected to and arranged radially within lateral wall 56 of section 50. In some embodiments, screen 40 abuts against both end 24 of section 20 and end 52 of section 50. It should be appreciated that screen section 20 is removably connected between or to at least one of sections 20 and 50. Furthermore, section 20 is removably connected to section 50. This enables screen 40 to be easily removed from reservoir assembly 10 such that it can be cleaned (e.g., if the powder color needs changing).

Agitator 30 is rotatably arranged in section 20 atop of screen 40. Agitator 30 comprises shaft 32 and at least one blade, for example blades 34A-D. Shaft 32 is non-rotatably connected to blades 34A-D and extends out of section 20 past end 22 in axial direction AD2. In some embodiments, shaft 32 extends through a hole in cap 23. In some embodiments, shaft 32 is connected to a motor or other automated rotation mechanism operatively arranged to rotated shaft 32 and thus blades 34A-D. Blades 34A-D are arranged proximate to, engage, and/or abut against screen 40. As blades 34A-D rotate, they force un-sifted powder 90 through the apertures in screen 40 at a predetermined rate. For example, slow rotation of blades 34A-D force un-sifted powder 90 through screen 40 at a slow rate and fast rotation of blades 34A-D force un-sifted powder 92 through screen 40 at a fast rate. Rotation of blades 34A-D also break up powder clumps and agglomerates.

In some embodiments, reservoir assembly 10 further comprises nozzle 60. Nozzle 60 is generally tubular and comprises end 62, end 64, and lateral wall 66. End 62 is connected to end 54. Outlet 70 is connected to end 64. In some embodiments, nozzle 60 is conical or frusto-conical and decreases in diameter in axial direction AD1.

Reservoir assembly 10 further comprises air inlet 80 through which an air stream is injected. As shown in FIG. 1A, air inlet 80 is arranged in end 22, or cap 23, and directs air into section 20 in axial direction AD1, represented by arrow A1. In the arrangement shown in FIG. 1A, since air is injected through air inlet 80 in axial direction AD1 on top of un-sifted powder 90, the injected air helps agitator 30 force powder through screen 40. Additionally, it is the mixture of powder with air that is crucial to powder coating. The creation of this mixture (i.e., the powder and air mixture) is referred to as fluidizing the powder. The combination of displacing un-sifted powder 90 over screen 40 by rotating agitator 30 causes separation of the powder as it passes through screen 40 thereby forming sifted powder 92. This fluidizes the powder. The injection of air further fluidizes the powder. In some embodiments, air inlet 80 is connected to lateral wall 26 and injects air into section 20 in circumferential direction CD1 or circumferential direction CD2, or in radial direction RD1.

To operate reservoir assembly 10, un-sifted powder 90 is loaded into section 20 and cap 23 is secured to end 22. Air is injected into section 20 via air inlet 80 and agitator 30 is displaced in a circumferential direction relative to screen 40 (e.g., circumferential direction CD1 or circumferential direction CD2). Rotation of blades 34A-D displaces un-sifted powder 90 over mesh 44 of screen 40. Powder 90 falls through screen 40 as sifted powder 92 which mixes with air and fluidizes. Sifted powder 92 then exits reservoir assembly 10 through nozzle 60 and outlet 70, upon which it enters the powder coating spray gun. The powder coating spray gun further fluidizes and/or imparts a charge (e.g., negative charge) to sifted powder 92 and sprays it towards the grounded object to be coated (i.e., the workpiece). As is known in the art, charging of the powder may occur via corona or electrostatic charging, or triboelectric or friction charging.

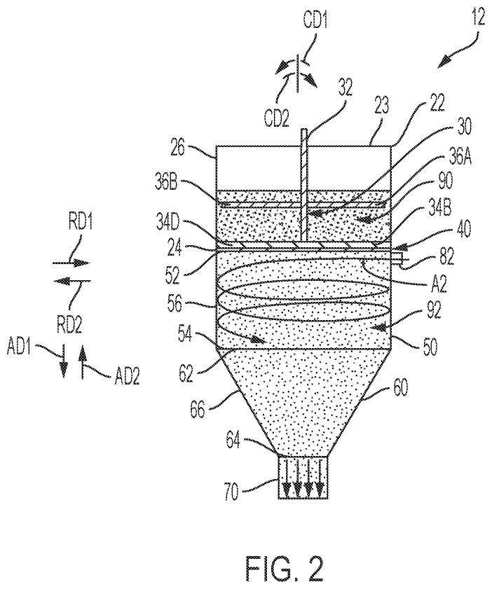

FIG. 2 is a side cross-sectional view of powder coating spray gun reservoir assembly or reservoir assembly 12. Reservoir assembly 12 is substantially the same as reservoir assembly 10. However, reservoir assembly 12 comprises air inlet 82 through which an air stream is injected. Air inlet 82 is arranged in lateral wall 56 and directs air into section 50 in circumferential direction CD1, represented by arrow A2. Thus, air inlet 82 can be arranged tangent to or substantially tangent to lateral wall 56. In some embodiments, air inlet 82 is arranged in lateral wall 56 and directs air into section 50 in circumferential direction CD2. Since air is injected through air inlet 82 in circumferential direction CD1 with sifted powder 92 as it falls through screen 40, fluidization of the powder occurs. It should be appreciated that in some embodiments, air inlet 82 may be arranged normal to lateral wall 56, thereby injecting air into section 50 in radial direction RD1.

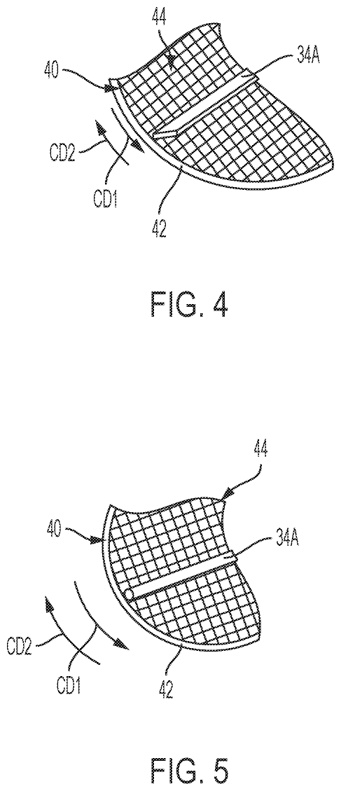

Reservoir assembly 12 further comprises at least one blade, for example blades 36A-B, non-rotatably connected to shaft 32 and spaced apart from blades 34A-D in axial direction AD2. Blades 36A-B are operatively arranged to break up powder clumps and agglomerates and maintain displacement of un-sifted powder 90 in axial direction AD1, or down through screen 40. In some embodiments, and similar to a ceiling fan, blades 36A-B are rectangular in cross section and are angled in order to force material downward in axial direction AD1. An example of such blade design will be described in greater detail with respect to FIG. 4.

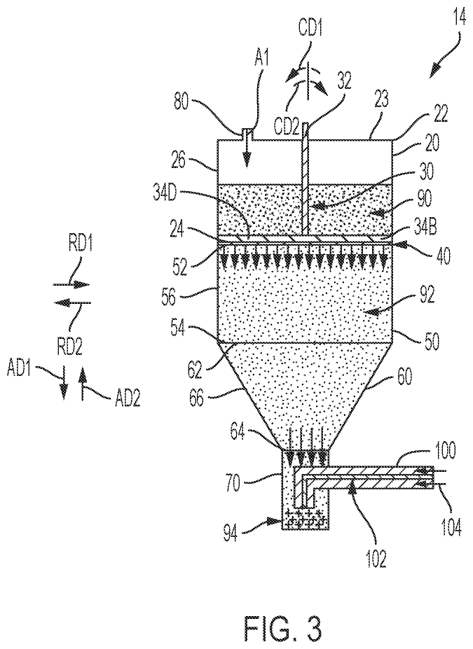

FIG. 3 is a side cross-sectional view of powder coating spray gun reservoir assembly or reservoir assembly 14. Reservoir assembly 14 is substantially the same as reservoir assembly 10. Reservoir assembly 14 further comprises a charging device arranged to charge the powder. The charging of the powder within reservoir assembly 14 may be performed as an alternative or in addition to the charging that occurs within the powder coating spray gun. As shown in FIG. 3, a corona charging device is arranged in outlet 70. Corona tube 100 extends radially into outlet 70. Corona electrode 102 is arranged within corona tube 100. Corona air supply 104 injects air through corona tube 100 and along corona electrode. As is known in the art, the flow of air along an electrode creates a corona discharge or an electrical discharge. Specifically, a corona discharge is an electrical discharge caused by the ionization of a fluid such as air surrounding a conductor carrying a high voltage. As ionized air leaves corona tube 100 it contacts sifted powder 92 thereby ionizing the powder and creating charged powder 94. Charged powder 94 may then be further charged (via corona or triboelectric charging), further fluidized, and/or sprayed at the workpiece via powder coating spray gun.

In some embodiments, as an alternative (or in addition to) the corona charging mechanism shown in FIG. 3, reservoir assembly 10, 12, 14 comprises a triboelectric charging mechanism wherein agitator 30 and/or screen 40 electrically charge the powder through contact. Triboelectric charging or the triboelectric effect is a type of contact electrification on which certain materials become electrically charged after they are separated from a different material with which they were in contact. Specifically, as friction occurs between un-sifted powder 90 and screen 40 and un-sifted powder 90 and blades 34A-D of agitator 30, the powder can be charged while it is sifted. In some embodiments, blades 34A-D and/or agitator 30 comprises TEFLON® polytetrafluoroethylene (PTFE) or a material coated in PTFE. It is known that as powder rubs against PTFE it picks up a positive charge and will adhere to a grounded workpiece.

FIG. 4 is a partial perspective view of blade 34A engaged with screen 40. As shown, blade 34A is generally rectangular in cross-section and is arranged at an angle relative to mesh 44 (similar to blades on a ceiling fan). As blade 34A rotates in circumferential direction CD1, it not only forces powder down through mesh 44 by way of its bottom surface, but it also pulls powder downward from above. In some embodiments, the bottom edge of blade 34A is arranged proximate to mesh 44. In some embodiments, the bottom edge of blade 34A abuts against mesh 44. It should be appreciated that rotation of blade 34A in either circumferential direction CD1 or circumferential direction CD2 will displace powder, and as a consequence powder will fall down through screen 40.

FIG. 5 is a partial perspective view of blade 34A engaged with screen 40. As shown, blade 34A is generally circular in cross-section. As blade 34A rotates in circumferential direction CD1 or circumferential direction CD2 it displaces powder and as a consequence powder will fall down through screen 40. In some embodiments, blade 34A is arranged proximate to mesh 44. In some embodiments, blade 34A abuts against mesh 44.

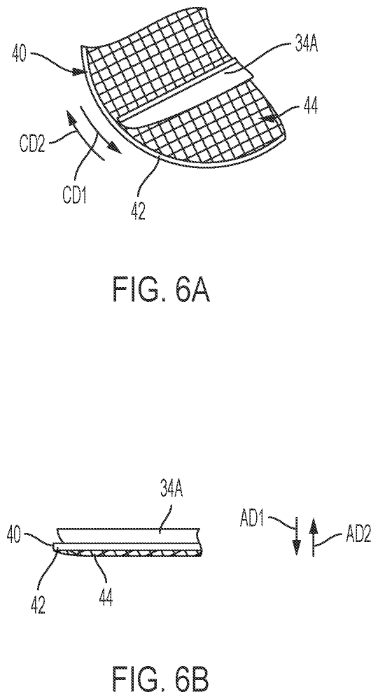

FIG. 6A is a partial perspective view of blade 34A engaged with screen 40. FIG. 6B is a partial elevational view of blade 34A engaged with screen 40. As shown, blade 34A is generally rectangular in cross-section and is arranged relatively perpendicular to mesh 44. Blade 34A comprises a curvilinear bottom surface or edge. As blade 34A rotates in circumferential direction CD1 or circumferential direction CD2 it displaces powder and as a consequence powder will fall down through screen 40. In some embodiments, and as shown in FIG. 6B, the curvilinear bottom surface of blade 34A is pressed into mesh 44 in axial direction AD1 to create even more friction between blade 34A and mesh 44. This may cause mesh 44 to drop below rim 42. In some embodiments, blade 34A is arranged proximate to mesh 44. In some embodiments, blade 34A abuts against mesh 44.

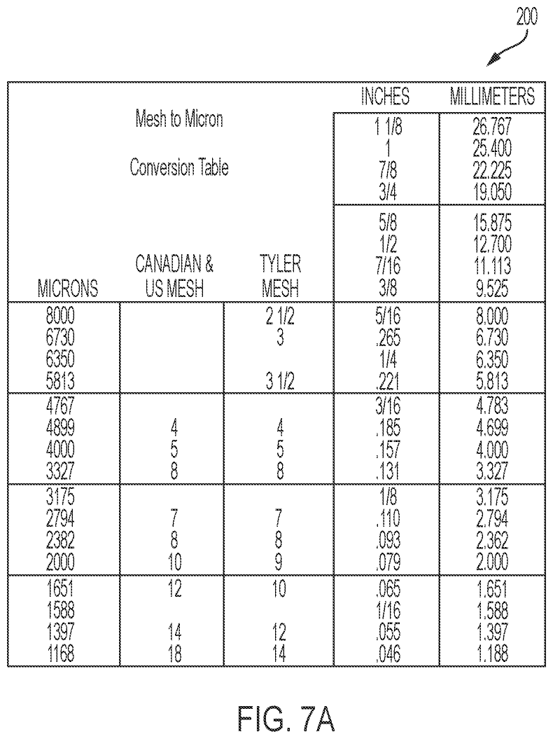

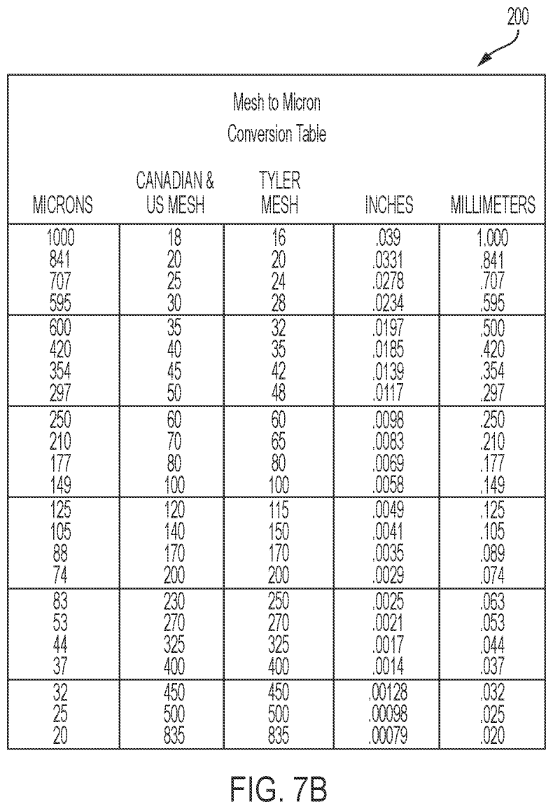

FIGS. 7A-B depict chart 200 showing mesh size for a screen to micron size for particles. The first column of chart 200 shows particle diameter sizes in microns (i.e., micrometer). The second column of chart 200 shows the standard Canadian and United States mesh size. The third column of chart 200 shows the Tyler Equivalent, or the Tyler Mesh Size or Tyler Standard Sieve Series. The fourth and fifth columns of chart 200 show the opening sizes of the corresponding mesh in inches and millimeters, respectively. Chart 200 or an equivalent chart can be used to determine the mesh size of mesh 44 of screen 40, based on the intended diameter of un-sifted particles 90.

The present disclosure also provides a method for fluidizing powder for use in a powder coating spray gun. In a first step, un-sifted powder 90 is loaded into and/or stored in first section 20. As previously described, cap 23 may then be secured to end 22 to enclose un-sifted powder 90 in section 20. Agitator 30 is then (rotatably) displaced relative to screen 40 in order to sift un-sifted powder 90 through screen 40, thereby forming sifted powder 92 in section 50. The sifting step removes clumps and agglomerates in un-sifted powder 90. The sifting step also helps in the fluidization process by separating powder particles and “sprinkling” them into air in section 50.

In some embodiments, an air stream is injected into the powder. For example, as shown in FIG. 1A, air inlet 80 injects an air stream into section 20 in axial direction AD1. This helps the sifting process by, in conjunction with agitator 30, urging and/or forcing powder through screen 40. This also mixes powder with air and helps the fluidization process. As shown in FIG. 2, air inlet 82 injects an air stream into section 50 in circumferential direction CD1. The mixture of air with sifted powder 92 helps the fluidization process.

In some embodiments, the powder is charged. For example, as shown in FIG. 3, corona tube 100 may be arranged in outlet 70 or nozzle 60 or section 50. Corona tube 100 including corona electrode 102 and corona air supply 104 that, using corona charging as previously described, charges sifted powder 92 prior to exiting reservoir assembly 14. Such arrangement provides the powder coating spray gun with charged powder 94. In some embodiments, at least one of agitator 30 and screen 40 comprises PTFE. For example, mesh 44 and/or blades 34A-D may be coated with PTFE. As un-sifted powder 90 interacts with agitator 30 and screen 40 during the sifting process, triboelectric charging occurs thereby forming sifted, and charged, powder 92 in section 50.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

10 Powder coating spray gun reservoir assembly
12 Powder coating spray gun reservoir assembly
14 Powder coating spray gun reservoir assembly
20 Section
22 End
23 Cap
24 End
26 Wall
30 Agitator
32 Shaft
34A Blade
34B Blade
34C Blade
34D Blade
36A Blade
36B Blade
40 Screen
42 Rim
44 Screen
50 Section
52 End
54 End
56 Wall
60 Nozzle
62 End
64 End
66 Wall
70 Outlet
80 Air inlet
82 Air inlet
90 Un-sifted powder
92 Sifted powder
94 Charged powder
100 Corona tube
102 Corona electrode
104 Corona air supply
200 Chart
A1 Arrow
A2 Arrow
AD1 Axial direction
AD2 Axial direction
CD1 Circumferential direction
CD2 Circumferential direction
RD1 Radial direction
RD2 Radial direction

What is claimed is:

1. A powder coating spray gun reservoir assembly, comprising:
a first section including a first end, a second end, and a first lateral wall extending between the first end and the second end;
a second section including a third end engaged with the second end, a fourth end, and a second lateral wall extending between the third end and the fourth end;
a screen removably arranged between the first section and the second section; and,
an agitator rotatably arranged in the first section, wherein the agitator is operatively arranged to rotate relative to the screen to displace powder from the first section to the second section.

2. The powder coating spray gun reservoir assembly as recited in claim 1, wherein the screen is non-rotatably connected to at least one of the first section and the second section.

3. The powder coating spray gun reservoir assembly as recited in claim 2, wherein the agitator is engaged with the screen.

4. The powder coating spray gun reservoir assembly as recited in claim 3, wherein the agitator comprises:
a shaft; and,
at least one first blade connected to the shaft and operatively arranged to rotatably engage the screen.

5. The powder coating spray gun reservoir assembly as recited in claim 4, wherein the agitator further comprises at least one second blade connected to the shaft and axially spaced apart from the at least one first blade.

6. The powder coating spray gun reservoir assembly as recited in claim 1, further comprising a nozzle connected to the fourth end, wherein the nozzle decreases in diameter in a first axial direction away from the fourth end.

7. The powder coating spray gun reservoir assembly as recited in claim 1, wherein the second section is removably connected to the first section.

8. The powder coating spray gun reservoir assembly as recited in claim 1, further comprising a cap removably connected to the first end.

9. The powder coating spray gun reservoir assembly as recited in claim 8, further comprising an air inlet arranged in the cap.

10. The powder coating spray gun reservoir assembly as recited in claim 9, wherein the air inlet is operatively arranged to direct an air stream into the first section in a first axial direction.

11. The powder coating spray gun reservoir assembly as recited in claim 1, further comprising an air inlet arranged in the second lateral wall.

12. The powder coating spray gun reservoir assembly as recited in claim 11, wherein the air inlet is operatively arranged to direct an air stream into the second section in a first circumferential direction.

13. The powder coating spray gun reservoir assembly as recited in claim 1, further comprising a corona charging device arranged in the second section to charge the powder.

14. The powder coating spray gun reservoir assembly as recited in claim 1, wherein at least one of the screen and the agitator comprises polytetrafluoroethylene (PTFE) and is operatively arranged to triboelectrically charge the powder.

15. A powder coating spray gun reservoir assembly, comprising:
a first section including a first end, a second end, and a first lateral wall extending between the first end and the second end;
a second section including a third end engaged with the second end, a fourth end, and a second lateral wall extending between the third end and the fourth end;
a nozzle connected to the fourth end, the nozzle decreasing in diameter in a first axial direction;
a screen removably secured between the first section and the second section;
an agitator rotatably arranged in the first section, the agitator including:
a shaft; and,
at least one first blade connected to the shaft and operatively arranged to engage the screen; and,
a charging device;
wherein the agitator is operatively arranged to rotate relative to the screen to displace powder from the first section to the second section.

16. The powder coating spray gun reservoir assembly as recited in claim 15, wherein the agitator further comprises at least one second blade connected to the shaft and axially spaced apart from the at least one first blade.

17. The powder coating spray gun reservoir assembly as recited in claim 15, wherein the second section is removably connected to the first section.

18. The powder coating spray gun reservoir assembly as recited in claim 15, further comprising an air inlet operatively arranged to direct an air stream into at least one of the first section and the second section.

19. The powder coating spray gun reservoir assembly as recited in claim 15, wherein the charging device comprises a corona charging device operatively arranged to charge the powder.

20. The powder coating spray gun reservoir assembly as recited in claim 19, further comprising an output connected to the nozzle, wherein the corona charging device is arranged in the outlet.

21. The powder coating spray gun reservoir assembly as recited in claim 20, wherein the corona charging device comprises:
a tube extending radially into the outlet; and,
an electrode arranged in the tube, wherein an air stream is directed through the tube along the electrode to ionize powder passing through the outlet.

22. The powder coating spray gun reservoir assembly as recited in claim 15, wherein the charging device comprises at least one element operatively arranged to triboelectrically charge the powder.

23. The powder coating spray gun reservoir assembly as recited in claim 22, wherein at least one of the screen and the agitator comprises polytetrafluoroethylene (PTFE) and is operatively arranged to triboelectrically charge the powder.

24. A method of fluidizing powder for use in a powder coating spray gun, the method comprising:
storing un-sifted powder in a first section;
using an agitator, sifting the un-sifted powder through a screen to form sifted powder in a second section; and,
injecting an air stream into at least one of the un-sifted powder and the sifted powder.

25. The method as recited in claim 24, further comprising:
charging the sifted powder using a corona charging device arranged proximate the second section.

26. The method as recited in claim 24, further comprising:
charging the un-sifted powder and/or the sifted powder triboelectrically using at least one of the screen and the agitator.

27. The method as recited in claim 24, wherein the step of storing un-sifted powder in the first section comprises:
storing a first un-sifted powder in the first section, the first un-sifted powder having a first color; and,
storing a second un-sifted powder in the first section, the second un-sifted powder having a second color, the second color being different than the first color.

28. The method as recited in claim 24, further comprising:
using the agitator, mixing the first un-sifted powder and the second un-sifted powder to form a third un-sifted powder, the third un-sifted powder having a third color, the third color being different than the first color and the second color.

29. The method as recited in claim 24, wherein the step of sifting the un-sifted powder through the screen to form the sifted powder comprises:
using the agitator, mixing the first un-sifted powder and the second un-sifted powder to form a third un-sifted powder, the third un-sifted powder having a third color, the third color being different than the first color and the second color; and,
using the agitator, sifting the third un-sifted powder through the screen to form the sifted powder in the second section.

30. The method as recited in claim 24, wherein the step of sifting the un-sifted powder through the screen to form the sifted powder comprises:
using the agitator and the screen, mixing and sifting the first un-sifted powder and the second un-sifted powder to form the sifted powder in the second section, the sifted powder having a third color, the third color being different than the first color and the second color.
